(19) United States
(12) Patent Application Publication
(10) Pub. No.: US 2015/0077347 A1
(43) Pub. Date: Mar. 19, 2015

(54) ERGONOMICALLY OPTIMIZED REMOTE CONTROLLER DEVICE AND METHOD OF USE THEREOF

(71) Applicant: Mark O'Green, North Las Vegas, NV (US)

(72) Inventor: Mark O'Green, North Las Vegas, NV (US)

(21) Appl. No.: 14/031,231

(22) Filed: Sep. 19, 2013

(51) Int. Cl. G06F 3/01; G06F 3/038; G06F 3/0354

(52) U.S. Cl. CPC G06F 3/014; G06F 3/03547; G06F 3/038; G06F 2203/0383; G06F 2203/0384; G06F 2203/0331
USPC 345/173

(57) ABSTRACT

An ergonomically optimized, finger-mounted, thumb-actuated remote controller device comprises a finger sleeve assembly having one or more finger sleeves designed to be worn over one or more fingers of the hand of a user; one or more control devices, such as a touchpad and an activation key, attached to the finger sleeves such that the control devices may be actuated by the thumb of the user; one or more batteries integrated into the finger sleeve assembly; a microprocessor integrated into the finger sleeve assembly; and a wireless transmitter integrated into the finger sleeve assembly.

### FIELD OF THE INVENTION

The present invention relates generally to the field of remote controllers. More particularly, the present invention provides a useful, novel, ergonomically optimized, finger-mounted, thumb-driven remote controller device for controlling one or more remote electronic device.

### BACKGROUND OF THE INVENTION

Unless otherwise indicated herein, the materials described in this section are not prior art to the claims in this application and are not admitted to be prior art by inclusion in this section.

The material in this patent document is subject to copyright protection under the copyright laws of the United States and other countries. The copyright owner grants a limited license to any member of the public to reproduce the patent document as it appears in official governmental records. All other copyrights rights are reserved.

A remote controller is a component of an electronics system that operates to control functions of a remotely located, remotely controlled device. Remote controllers having relevance to this disclosure operate without physical wires that connect the remote controller to the remotely controlled device.

The electronics age has seen a proliferation of progressively complex and ubiquitous remotely controlled devices, accompanied by a similarly proliferation of remote controllers to remotely control those devices.

Well-known and familiar remotely controlled devices include televisions, cable-television boxes, home theater and stereo system components, computers, portable media players, and gaming consoles. The future will bring even more ubiquitous remotely controlled devices as virtual and augmented reality works its way into everyday life.

Those with knowledge in the art of remote controller devices will be familiar with conventional remote controller devices. Common remote controller devices were originally used for operating a remotely controlled device from a short line-of-sight distance. Such remote controller devices employ receiver/transmitter technology such as radio frequency or consumer infrared. These remote controller devices typically comprise a plurality of buttons designed and configured to control the various functions of the remotely controlled device.

Remote controller devices have evolved and advanced to include Bluetooth® connectivity, motion sensor enabled capabilities, and voice control. Simple buttons have been replaced or augmented with more sophisticated actuator components such as joysticks, touchpads, trackpads, accelerometers, position sensors, and actuation keys as the sophistication of the functions to be controlled has increased.

The embodiment of remote controller devices has similarly evolved and advanced. The familiar handheld television remote controller, typically a block-shaped box having a plurality of buttons, has been joined in the marketplace by more capable and sophisticated remote controller devices tailored to unique application. Examples include remote keyboard and mouse devices for controlling computers and game controllers featuring ergonomics-driven shapes and actuator components such as joysticks and motion sensors.

A relatively new and expanding field wherein remote controller devices will play a significant role is the field of virtual and augmented reality and virtual and augmented reality displays. The physical and functional requirements associated with application of human-machine interface in the virtual and augmented reality environment render conventional remote controller devices impractical and insufficient.

A type of remote controller device known as a data glove or wired glove is an input device for human-computer interaction. Worn like a glove, a data glove may comprise and utilize various sensor technologies, combined with software that interprets the data from the sensors, to translate physical data, such as the orientation of a hand or the motion of a finger, to inputs that may be used to control computer and robotic devices. Zimmerman discloses an early data glove design in U.S. Pat. No. 4,542,291. Data gloves are expected to play a role in virtual and augmented reality environments. However, conventional data glove technology is ungainly and expensive.

One example of virtual reality display technology is augmented reality eyewear, such as Google Glass®. Google Glass® is a computer that may be worn by a user and features an optical head-mounted display. A principal objective of Google Glass® is to display information to a user in a hands-free format, and to interact with the Internet via natural language voice commands.

In U.S. Pat. No. 8,203,502, Chi, et al. discloses an input control device for a heads-up display, or augmented reality eyewear, wherein a finger-operable input device is secured to the frame of the augmented reality eyewear. Functionally, this input device is a track pad that senses position and/or movement of a user's finger relative to the track pad and provides input information to the heads-up display device corresponding to that position and/or movement. The sub-optimal ergonomics of this design result in the disadvantage of requiring the user to place the user's hand in proximity to the track pad, located near the temple of the user's head, and to maintain the user's hand in that position for the duration of the data input process. A further disadvantage is that the track pad is neither located within the user's field of vision, nor oriented with respect to the user's hand or fingers. Therefore, the user must reach up toward the user's temple, locate the frame of the eyewear by sense of touch, and then locate the track pad on the eyewear by sense of touch. The controller device disclosed by Chi is inconsistent with the hands-free objective of virtual reality devices such as Google Glass®.

In Patent Application Publication Number 20130016070, Starner, et al. disclose a virtual input system, intended for use with a remote controlled device such as Google Glass®, that includes a projector and a camera. The projector projects a pattern onto a surface. The camera then captures images as a user moves the user's hand in the projected pattern. A processor may interpret the images to determine actions to be implemented. Here, the disclosed device is inconsistent with the intended heads up function of a device such as Google Glass®, in that the user must look down to view and manipulate the projected pattern in order to control the remote device.

What is needed is a remote controller device that is versatile and may be adapted to use with a variety of remotely controlled devices; that provides a hands-free and heads up interface to remotely controlled devices; that is highly portable, unobtrusive and inconspicuous; that does not interfere with the ability of the user to use the user's hands for other tasks; and that provides comfortable and ergonomically-optimized user interface and ease of use.

### SUMMARY OF THE INVENTION

In view of the foregoing limitations and disadvantages inherent to the conventional apparatus in the relevant art, the present invention provides a useful and novel apparatus [hereinafter “ergonomic remote controller”] for controlling a remote device.

A principal objective of the present invention is to provide a hands-free and heads up interface to remotely controlled devices.

In one aspect, the present invention may comprise a finger sleeve assembly further comprising a middle finger sleeve and an index finger sleeve, a wireless transmitter, a microprocessor, a touchpad integrated into the middle finger sleeve and located on the side of the middle segment of the user's middle finger proximal to the index finger, and an activation key integrated into the index finger sleeve and located on the front middle segment of the user's index finger. This exemplary configuration allows the user to operate the invention without looking at the device, relying instead upon the ergonomically optimized location of the touchpad and the activation key and tactile response to maintain orientation between the user's hand and the remote controller device. Further, the present invention may incorporate a wireless transmitter to eliminate the need for the user's hand to interface with the remotely controlled device.

Another objective of the present invention is to provide a remote controller device that is highly portable, unobtrusive and inconspicuous.

In one aspect, the ergonomic remote controller of the present invention is small and lightweight and may be worn on the fingers of the user, making the device highly portable, unobtrusive and inconspicuous. The ergonomic remote controller may be used while the user is engaged in a variety of activities including, but not in a limiting sense, walking, jogging, and riding in or operating a vehicle. Further, the device may be used while the user's hand is out of sight, for example in the user's pocket, making the device essentially undetectable.

Another objective of the present invention is to provide a remote controller device that does not interfere with the ability of the user to use the user's hands for other tasks.

In a further aspect of the present invention, the finger sleeve assembly of the present invention may be designed and configured to leave the user's hand free to perform other tasks. For example, the individual finger sleeves of the finger sleeve assembly may fit over only the base and middle segments of the user's index and middle fingers, thereby leaving the remainder of the user's hand, most notably the palm and finger tip segments, free to perform other tasks.

Another objective of the present invention is to provide a remote controller device that comfortable and ergonomically optimized user interface and ease of use.

In one aspect of the present invention, the touchpad may be located on the side of the middle segment of the middle finger, proximal to the index finger, and the activation key may be located on the front of the middle segment of the index finger. These locations are ergonomically optimized to interface comfortably and accurately with the tip segment of the user's thumb.

A principal object of the present invention is to provide a remote controller device that is versatile and may be adapted to use with a variety of remotely controlled devices.

In one aspect, the present invention may be adapted to a wide variety of embodiments as required to control a virtually any remotely controlled device. The device may comprise any number of finger sleeves, and may incorporate a any number of actuation device types.

Other objects, aspects and advantages of the present invention will become readily apparent to those with skill in the relevant art from the following figures, descriptions and claims. As will be appreciated by those with skill in the relevant art, the invention may be implemented in a plurality of equivalent embodiments. Such alternative embodiments, and their attendant objects, aspects and advantages, are within the scope of the present invention and, therefore, the examples set forth herein shall not be limiting.

### BRIEF DESCRIPTION OF THE DRAWINGS

The nature of this invention, as well as all its objects, aspects and advantages, will become readily apparent and understood upon reference to the following detailed description when considered in conjunction with the accompanying drawings, in which like reference numerals designate like parts throughout the figures thereof, and wherein:

FIG. 1 presents a front view of the hand of a user of an ergonomic remote controller according to exemplary embodiments of the invention, as a reference and guide to terminology used in the disclosure of the invention;

FIG. 2 presents an exploded back view of an ergonomic remote controller, according to one exemplary embodiment of the invention;

FIG. 3 presents a perspective view of the ergonomic remote controller of FIG. 2, shown as worn on the hand of a user;

FIG. 4 presents a back view of the ergonomic remote controller of FIG. 2, shown as worn on the hand of a user;

FIG. 5A presents a perspective view of the ergonomic remote controller of FIG. 2, illustrating the device in use;

FIG. 5B presents a perspective view of the ergonomic remote controller of FIG. 2, illustrating the device in use;

FIG. 6 presents a block diagram of the ergonomic remote controller of FIG. 2;

FIG. 7 presents a perspective view of an alternative embodiment of an ergonomic remote controller, shown as worn on the hand of a user;

FIG. 8A presents a top view of a pod of the ergonomic remote controller of FIG. 7;

FIG. 8B presents a side view of the pod of FIG. 8A;

FIG. 8C presents a front view of the pod of FIG. 8A; and

FIG. 8D presents a rear view of the pod of FIG. 8A.

### DETAILED DESCRIPTION OF THE INVENTION

The following description is provided to enable a person skilled in the relevant art to make and use the invention, and sets forth the best modes contemplated by the inventor of carrying out the invention. The present invention shall not be limited to the examples disclosed. Rather, the scope of the invention shall be as broad as the claims will allow.

Various inventive features are described below that can each be used independently of one another or in combination with other features. However, any single inventive feature may not address any of the disadvantages discussed above, or might only address one of the disadvantages discussed above. Further, one or more of the disadvantages discussed above may not be fully addressed by any of the features described below.

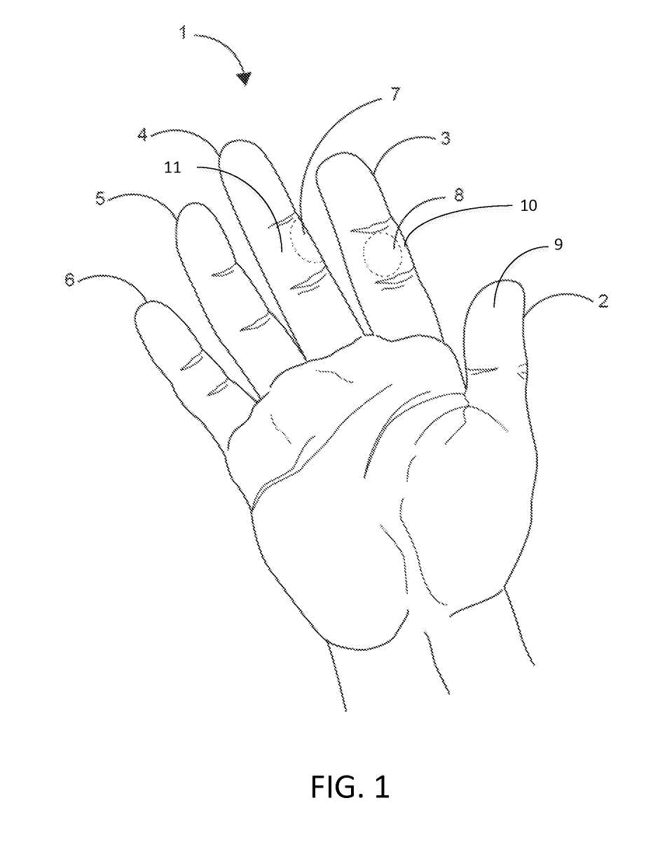

Referring now to the drawings, FIG. 1 presents a view of the hand 1 of a user of an ergonomic remote controller, provided as a reference and guide to terminology used in the disclosure of the invention. The hand 1 comprises a thumb 2, an index finger 3, a middle finger 4, a ring finger 5, and a little finger 6. An ergonomically optimal location 7 is shown, defined as the location on the side of the middle segment 11 of the middle finger 4 proximal to the index finger 3 where the tip segment 9 thumb 2 may easily interface with a device mounted at that location. An ergonomically optimal location 8 is shown, defined as the location on the front of the middle segment 10 of the index finger 3 where the tip segment 9 of the thumb 2 may easily interface with a device mounted at that location.

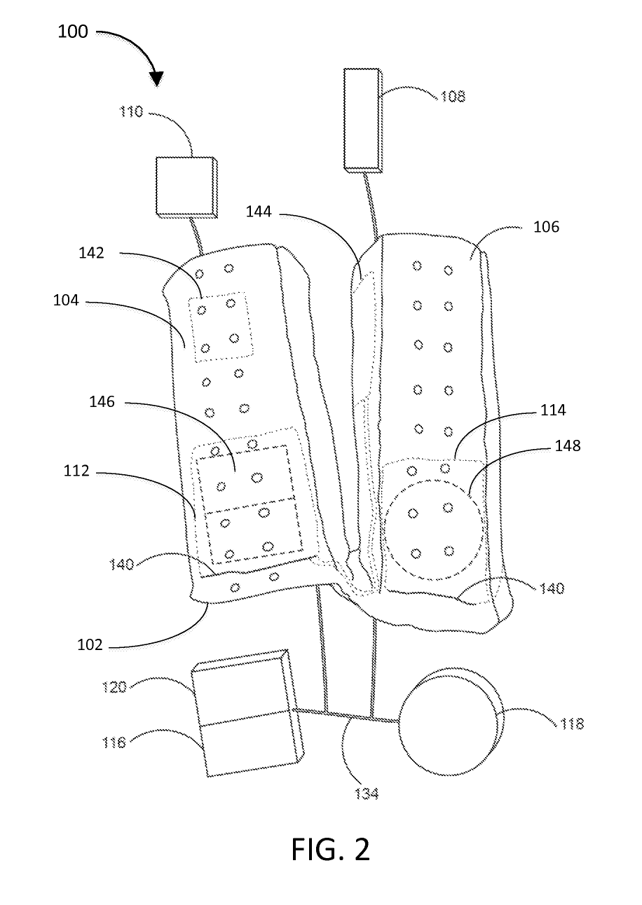

FIG. 2 presents an exploded back view of an ergonomic remote controller 100, according to one exemplary embodiment of the invention. In this exemplary embodiment, a finger sleeve assembly 102 may comprise an index finger sleeve 104 and a middle finger sleeve 106. The index finger sleeve 104 and the middle finger sleeve 106 may be designed and configured to be worn on the index finger 3 and the middle finger 4, respectively, of the hand 1. In this embodiment, a touchpad 108 may be integrated into the middle finger sleeve 106 at the noted location 144 on the outer surface of the middle finger sleeve 106. The noted location 144 corresponds to the ergonomically optimal location 7 defined in FIG. 1. An activation key 110 may be integrated into the index finger sleeve 104 at the noted location 142 on the outer surface (far side in FIG. 2) of the index finger sleeve 104. The noted location 142 corresponds to the ergonomically optimal location 8 defined in FIG. 1.

This embodiment is selected for disclosure because of the general usefulness of a touchpad 108/activation key 110 combination in a remote controller for many remote devices, and because it incorporates that useful touchpad 108/activation key 110 combination into highly-ergonomically convenient locations of the user's hand 1. It will be readily appreciated by those with skill in the relevant arts, and to the reader of this disclosure by placing the reader's thumb against the ergonomically optimal locations 7/8 of the reader's fingers, that the tip segment 9 of the thumb 2 may interface easily, comfortably, and accurately with the ergonomically optimal location 7 of the middle finger 4, and that the tip segment 9 of the thumb 2 may interface easily, comfortably, and accurately with the ergonomically optimal location 8 of the index finger 3.

In an alternative embodiment of the present invention, the activation key 110 may be integrated into the index finger sleeve 104 over the tip segment of the user's index finger. This location is ergonomically equivalent to the middle segment of the user's index finger.

The middle finger sleeve 106 and the index finger sleeve 104 may be made of any suitable and useful material, including, but not limited to polyester, cotton, spandex, neoprene, leather or suede. Materials may be selected in consideration of comfort, durability, appearance, the environment and/or conditions in which the ergonomic remote controller 100 may be used, or other considerations.

The middle finger sleeve 106 and the index finger sleeve 104 may be constructed of one layer of material or of multiple layers of material, such as a waterproof exterior layer over a more comfortable inner layer.

A touchpad (also known as a trackpad) is a pointing device featuring a tactile sensor surface that may translate the motion and position of a user's finger or thumb into an electrical signal that may be communicated to the device that is controlled by the touchpad. The motion and position of a user's finger or thumb on the touchpad may be translated into a relative motion or position on a display screen, or within the database that models the function of a display screen, and may typically function to scroll up, down, left or right on a display screen or through a database. Some touchpads may also interpret a tap of a user's finger or thumb as a click/select function, and a tap followed by a continuous sliding motion as a drag command.

For the purpose of the present invention, the term “touchpad” is intended to include any and all devices that may perform the function of translating the touch, position and/or motion of the user's finger or thumb into position and/or motion data for controlling motion and/or position on a screen or within a database. The touchpad may also include a select function for selecting a position on a screen or a portion of a database. The term “touchpad” therefore includes devices such as touch screens and flexible touch films.

The touchpad 108 may readily be selected by one with skill in the relevant arts from currently available designs or from designs that may become available in the future. The touchpad 108 may be selected in consideration of factors such as desired functionality, size, accuracy, physical integration into an ergonomic remote controller 100, durability, and cost.

The touchpad 108 may be integrated into the ergonomic remote controller 100 in a variety of ways, depending primarily upon the design of the selected touchpad 108, including sewing or bonding the touchpad 108 onto the middle finger sleeve 106 of the finger sleeve assembly 102.

An activation key is a device (typically a pressure, temperature, or electrostatic sensor/switch) that may sense the tap of a user's finger or thumb and translate that tap into a command, such as on/off or select.

The activation key 110 may readily be selected by one with skill in the relevant arts from currently available designs or from designs that may become available in the future. The activation key 110 may be selected in consideration of factors such as desired functionality, size, physical integration into an ergonomic remote controller 100, durability, and cost.

The activation key 110 may be integrated into the ergonomic remote controller 100 in a variety of ways, depending primarily upon the design of the selected activation key 110, including sewing or bonding the activation key 110 onto the index finger sleeve 104 of the finger sleeve assembly 102.

The ergonomic remote controller 100 may further comprise a battery 118, a wireless transmitter 116, and a microprocessor 120.

In the exemplary embodiment of FIG. 2, the battery 118 may be incorporated into the middle finger sleeve 106 of the finger sleeve assembly 102, positioned over the base segment of the user's middle finger 4.

The battery 118 may be designed and configured to provide power to the electronic components of the ergonomic remote controller 100. The battery 118 may readily be selected by one with skill in the relevant arts from currently available designs or from designs that may become available in the future. The battery 118 may be selected in consideration of factors such as power out requirements and duty cycles, size, physical integration into an ergonomic remote controller 100, durability, and cost.

In alternative embodiments of the present invention, the battery 118 may be replaced by another power source, such as a plurality of batteries or a battery pack. The power source may be replaceable and/or rechargeable. The power source may be a device capable of generating power, such as a solar cell.

A wireless transmitter 116 may be incorporated into the index finger sleeve 104 of the finger sleeve assembly 102, positioned over the base segment of the user's index finger 3.

The wireless transmitter 116 may be designed and configured to transmit data and/or commands from the ergonomic remote controller 100 to the remote device to be controlled. The wireless transmitter 116 may readily be selected by one with skill in the relevant arts from currently available designs or from designs that may become available in the future. The wireless transmitter 116 may be selected in consideration of factors such as desired functionality, size, physical integration into an ergonomic remote controller 100, durability, and cost.

Alternative embodiments of an ergonomic remote controller may incorporate Bluetooth® wireless technology, a standard for exchanging data over short distances, in the ergonomic remote controller's wireless transmitter.

A microprocessor 120 may be incorporated into the middle finger sleeve 106 of the finger sleeve assembly 102, positioned over the base segment of the user's middle finger 4.

The microprocessor 120 may be designed and configured to perform the signal and/or data processing functions of the ergonomic remote controller 100. The microprocessor 120 may readily be selected and configured by one with skill in the relevant arts from currently available designs or from designs that may become available in the future. The microprocessor 120 may be selected in consideration of factors such as processing requirements, size, physical integration into an ergonomic remote controller 100, durability, and cost.

The battery 118, the wireless transmitter 116, and the microprocessor 120 may be physically integrated into the ergonomic remote controller 100 in any of a variety of ways. In the exemplary embodiment shown in FIG. 2, the battery 118 may be housed within a pocket 114 that may be a feature of the middle finger sleeve 106. Similarly, the wireless transmitter 116 and the microprocessor 120 may be housed within a pocket 112 that may be a feature of the index finger sleeve 104. The pockets 112/114 may have openings 140 to accommodate removal and/or replacement of the battery 118, the wireless transmitter 114 and/or the microprocessor 120. The openings 140 may have a feature to maintain the openings 140 in a closed position once the battery 118, the wireless transmitter 114 and/or the microprocessor 120 have been installed, such as a hook-and-loop fastener.

FIG. 2 illustrates the installed position 148 of the battery 118 in the pocket 114, and the installed position 146 of the wireless transmitter 116 and the microprocessor 120 in the pocket 112.

The various electronic components may be electrically interconnected by means of an electrical conductor set 134.

In alternative embodiments of the present invention, the battery 118, the wireless transmitter 116 and/or the microprocessor 120 may be located at locations of the finger sleeve assembly 102 other than those shown in the exemplary embodiment of FIG. 2. While the location of the touchpad 108 and the activation key 110 as illustrated in FIG. 2 is essential to the ergonomic functionality of the invention, the battery 118, the wireless transmitter 116 and/or the microprocessor 120 may be placed at any useful location.

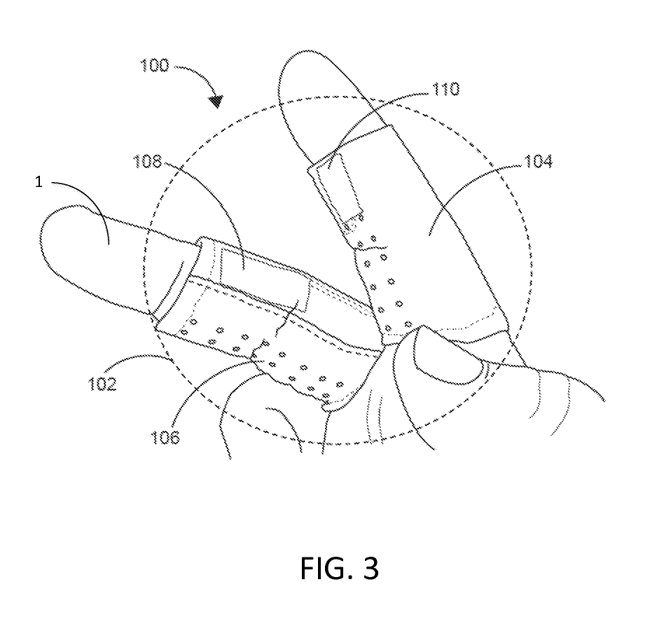

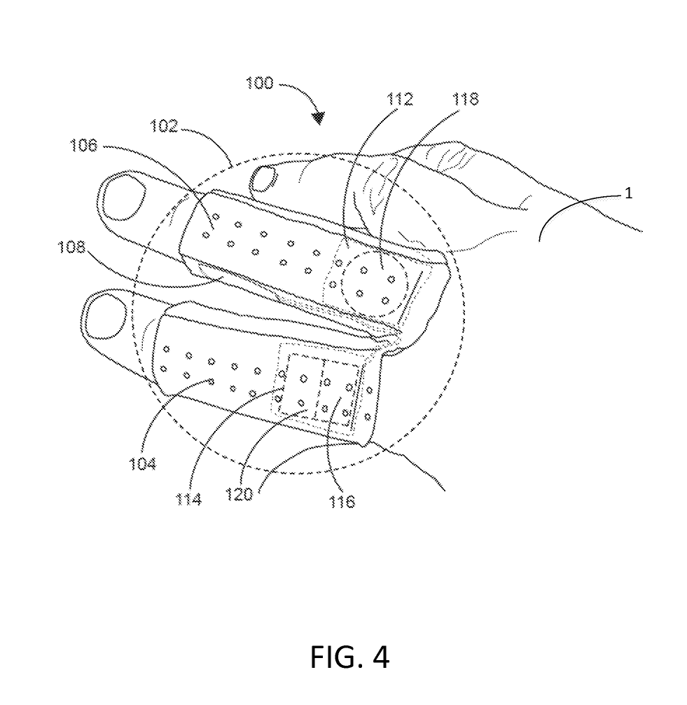

FIG. 3 presents a perspective view of the ergonomic remote controller 100 illustrating the ergonomic remote controller as worn on the hand 1 of a user. FIG. 4 presents a back view of the ergonomic remote controller 100 illustrating the ergonomic remote controller as worn on the hand 1 of a user.

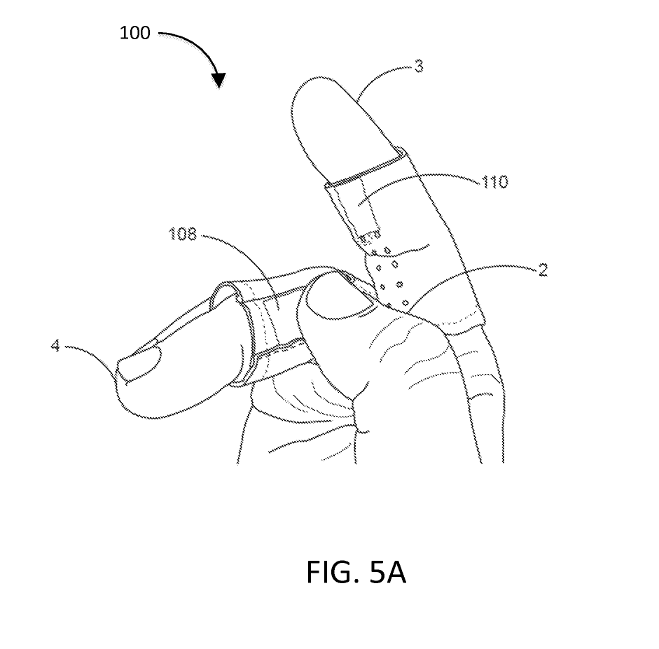

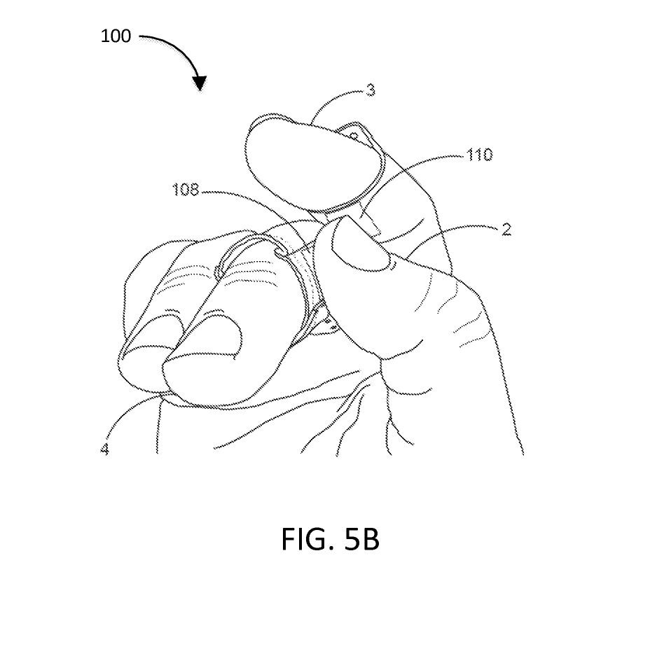

FIGS. 5A and 5B present perspective views illustrating an ergonomic remote controller 100 in use. FIG. 5A illustrates the user's thumb 2 in position to operate the touchpad 108. FIG. 5B illustrates the user's index finger 3 in position to enable the user's thumb 2 to actuate the activation key 110 while the user's thumb 2 is in position on the touchpad 108. To use the ergonomic remote controller 100 according to this exemplary embodiment, the user may translate the user's thumb 2 about the surface of the touchpad 108 to scroll up, down, left or right (for example, to position a cursor to a desired location on a display screen or within a database that models the function of a display screen, or to scroll through a listing of data and/or commands). Once the cursor is in the desired position, the user may actuate the activation key 110 function by moving the user's index finger 3 to the user's thumb 2, thereby causing the user's thumb 2 to come into contact with the activation key 110.

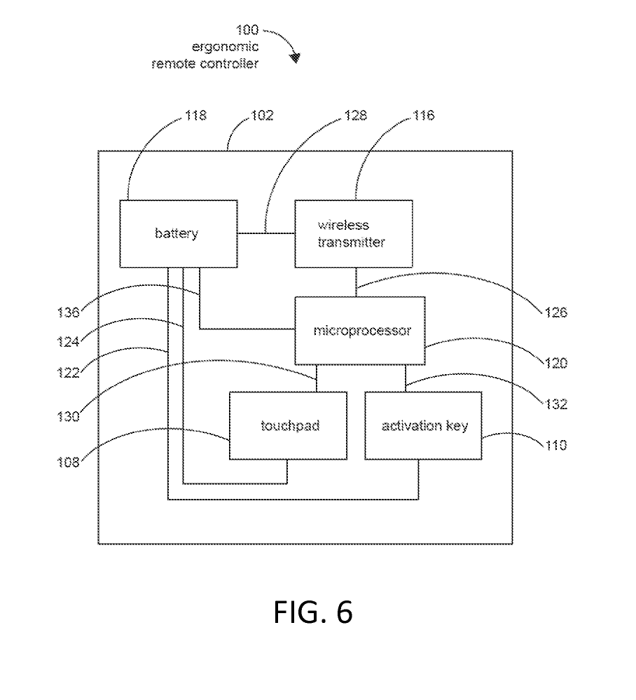

FIG. 6 presents a block diagram of an ergonomic remote controller 100, according to one exemplary embodiment of the invention. A touchpad 108, an activation key 110, a wireless transmitter 116, a microprocessor 120, and a battery 118 may be physically integrated into a finger sleeve assembly 102. An electrical conductor 124 may transfer operating electrical power from the battery 118 to the touchpad 108. An electrical conductor 122 may transfer operating electrical power from the battery 118 to the activation key 110. An electrical conductor 128 may transfer operating electrical power from the battery 118 to the wireless transmitter 116. An electrical conductor 136 may transfer operating power from the battery 118 to the microprocessor 120. An electrical conductor 130 may transfer electrical signals between the touchpad 108 and the microprocessor 120. An electrical conductor 132 may transfer electrical signals between the activation key 110 and the microprocessor 120. An electrical conductor 126 may transfer electrical signals between the microprocessor 120 and the wireless transmitter 116.

The electrical conductors 122/124/126/128/130/132/136 may comprise an electrical conductor set 134, and may be implemented in a variety of ways. In one exemplary embodiment, the electrical conductors 122/124/126/128/130/132/136 may be electrical wires that may be routed between the relevant electrical components, as illustrated in FIG. 6. Physically, the electrical conductors 122/124/126/128/130/132/136 may be routed along the inner surface of the finger sleeve assembly 102. Alternatively, the electrical conductors 122/124/126/128/130/132/136 may be routed along the outer surface of the finger sleeve assembly 102. In yet another alternative embodiment, the electrical conductors 122/124/126/128/130/132/136 may be routed between the inner and outer layers of a multi-layer finger assembly sleeve 102.

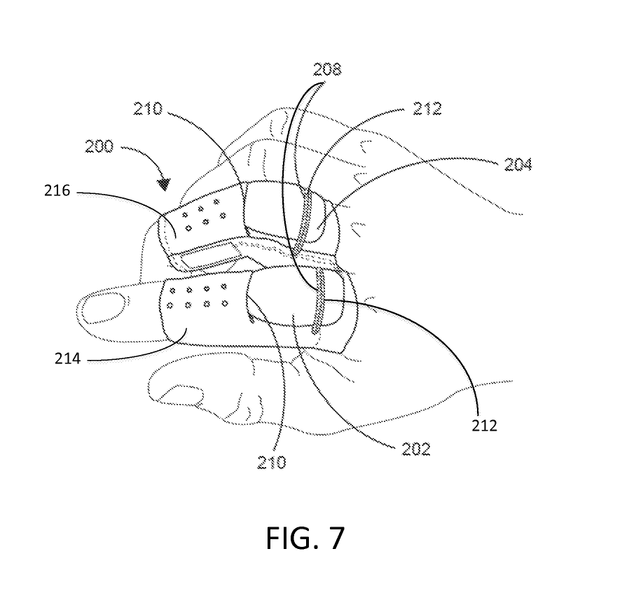

FIG. 7 presents a perspective view of an alternative embodiment of an ergonomic remote controller 200, shown as worn on the hand of a user. The design and configuration of this alternative embodiment may be essentially the same as that of the ergonomic remote controller 100 presented in FIG. 2, except that in this embodiment, a battery pod 204 may house the system's battery 118, and an electronics pod 202 may house the wireless transmitter 116 and microprocessor 120.

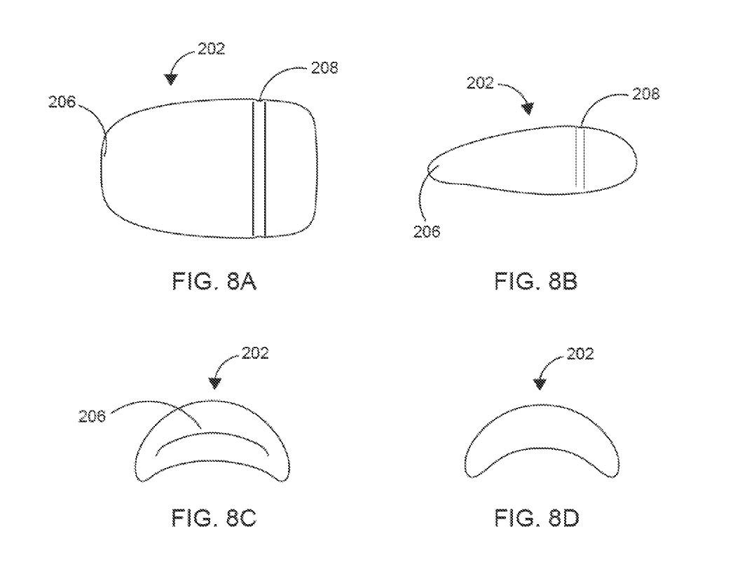

FIG. 8 illustrates one exemplary shape of a pod, using the electronics pod 202 as the example. In the exemplary embodiment of FIG. 7, the shape of the battery pod 204 may be the same as the shape of the electronics pod 202, although it may be substantially different in alternative embodiments. FIG. 8A presents a top view of the electronics pod 202. FIG. 8B presents a side view of the pod of the electronics pod 202. FIG. 8C presents a front view of the electronics pod 202. FIG. 8D presents a rear view of the electronics pod 202. The electronics pod 202 has a leading edge 206 and a groove 208 to secure the electronics pod 202 in the ergonomic remote controller 200.

FIG. 7 presents the electronics pod 202 in its installed condition. To install the electronics pod 202 into the ergonomic remote controller 200, the leading edge 206 of the electronics pod 202 may be inserted into a slot 210 designed into the index finger sleeve 214 of the ergonomic remote controller 200, thereby restraining the leading edge 206. Then, a retainer 212, which is designed into the index finger sleeve 214 of the ergonomic remote controller 200, may be lifted over the rear of the electronics pod 202 and placed into the groove 208, thereby restraining the entire electronics pod 202. The retainer 212 may be of any useful design, including but not limited to an elastic band.

The installation of the battery pod 204 may be identical to that of the electronics pod 202, except the battery pod 204 may be installed into the middle finger sleeve 216 of the ergonomic remote controller 200.

In alternative embodiments of the invention, an ergonomic remote controller may be configured to be worn on a user's left hand or right hand.

Alternative embodiments of an ergonomic remote controller may have one, two, three or four finger sleeves configured to be worn on any combination of a user's fingers. In addition, alternative embodiments of an ergonomic remote controller may have a thumb sleeve configured to be worn on a user's thumb.

In alternative embodiments of the invention, an ergonomic remote controller may be designed and configured for use with any remote device for which an ergonomic remote controller may be useful, including, but not limited to computer/video games, remote control vehicles, tablet computers, digital music players, smart phones, heads up displays and virtual reality displays.

In alternative embodiments of the invention, an ergonomic remote controller may incorporate a plurality of touchpads and/or activation keys. Further, one or more other finger and/or thumb actuated elements may be incorporated into an ergonomic remote controller, such as a joystick, a touch wheel or a click wheel.

In alternative embodiments of the invention, any number and/or type of controller elements, such as touchpads and activation keys, may be located at various positions on the user's fingers or thumbs.

In alternative embodiments of the invention, one or more of the electronic elements of an ergonomic remote controller may be removable and/or replaceable.

Multiple ergonomic remote controllers may be configured to work in conjunction with each other. For example, one ergonomic remote controller may be worn on and operated with a user's right hand to control certain functions of a remote device, and a second ergonomic remote controller may be worn on and operated with a user's left hand to control other functions of the remote device.

The elements of an ergonomic remote controller may be modified, interchanged, separated or combined, or additional elements added without departing from the spirit of the invention. The invention may be practiced in alternative embodiments other than those illustrated in the Figures. Such modifications, combinations, additions and alternatives are within the contemplation of the present invention. The exemplary embodiments and disclosed are not intended to limit the scope of this invention. Accordingly, the scope of the invention should be determined not by the embodiments illustrated, but by their legal equivalents, and shall be as broad as the claims will allow.

What is claimed is:

1. An ergonomic remote controller device, comprising:
a finger sleeve assembly, having one or more finger sleeves, designed and configured to be worn over one or more fingers of the hand of a user;
one or more control devices attached to said one or more finger sleeves such that said one or more control devices may be actuated by the thumb of said user;
one or more batteries integrated into said finger sleeve assembly;
a wireless transmitter integrated into said finger sleeve assembly;
a microprocessor integrated into said finger sleeve assembly;
electrical conductors for distributing power from said one or more batteries to said control devices, wireless transmitter and microprocessor; and
electrical conductors for communicating electrical signals between said one or more control devices, wireless transmitter and microprocessor.

2. The ergonomic remote controller device of claim 1, wherein said control devices are selected from a group consisting of activation keys, switches, touchpads, touch screens, touch films, joysticks, accelerometers, position sensors, motion sensors, electrostatic sensors, control pads, d-pads and click wheels.

3. An ergonomic remote controller device, comprising:
a finger sleeve assembly, having a first finger sleeve designed and configured to be worn over the index finger of a user and a second finger sleeve designed and configured to be worn over the middle finger of said user;
an activation key affixed to the outer surface of said first finger sleeve such that said activation key is oriented over the front of the middle segment of said user's index finger;
a touchpad affixed to the outer surface of said second finger sleeve such that said touchpad is oriented over the side of the middle segment of the middle finger of said user proximal to the index finger;
one or more batteries integrated into said finger sleeve assembly;
a wireless transmitter integrated into said finger sleeve assembly;
a microprocessor integrated into said finger sleeve assembly;
electrical conductors for distributing power from said one or more batteries to said activation key, touchpad, wireless transmitter and microprocessor; and
electrical conductors for communicating electrical signals between said activation key, touchpad, wireless transmitter and microprocessor.

4. The ergonomic remote controller device of claim 3, wherein said activation key is affixed to the outer surface of said first finger sleeve such that said activation key is oriented over the front of the tip segment of said user's index finger.

5. The ergonomic remote controller device of claim 3, wherein said one or more batteries are integrated into said finger sleeve assembly by means of one or more pockets integrated into said finger sleeve assembly.

6. The ergonomic remote controller device of claim 3, wherein said wireless transmitter is integrated into said finger sleeve assembly by means of a pocket integrated into said finger sleeve assembly.

7. The ergonomic remote controller device of claim 3, wherein said microprocessor is integrated into said finger sleeve assembly by means of a pocket integrated into said finger sleeve assembly.

8. The ergonomic remote controller device of claim 3, wherein said one or more batteries are integrated into said finger sleeve assembly by means of one or more battery pods.

9. The ergonomic remote controller device of claim 3, wherein said wireless transmitter is integrated into said finger sleeve assembly by means of an electronics pod.

10. The ergonomic remote controller device of claim 3, wherein said microprocessor is integrated into said finger sleeve assembly by means of an electronics pod.

11. A method of controlling a remote device, comprising:
(a) providing a finger sleeve assembly, said finger sleeve assembly comprising:
a first finger sleeve designed and configured to be worn over the index finger of a user and a second finger sleeve designed and configured to be worn over the middle finger of said user;
an activation key affixed to the outer surface of said first finger sleeve such that said activation key is oriented over the front of the middle segment of said user's index finger;
a touchpad affixed to the outer surface of said second finger sleeve such that said touchpad is oriented over the side of the middle segment of the middle finger of said user proximal to the index finger;
one or more batteries integrated into said finger sleeve assembly;
a wireless transmitter integrated into said finger sleeve assembly;
a microprocessor integrated into said finger sleeve assembly;
electrical conductors for distributing power from said one or more batteries to said activation key, touchpad, wireless transmitter and microprocessor; and
electrical conductors for communicating electrical signals between said activation key, touchpad, wireless transmitter and microprocessor;
(b) placing the tip segment of the thumb of a user onto the surface of said touchpad;
(c) translating said tip segment of said user's thumb about the surface said touchpad, thereby actuating said touchpad; and
(d) moving said index finger of said user to said user's thumb such that said activation key comes into contact with said tip of said user's thumb, thereby actuating said activation key.

12. The method of claim 11, wherein said touchpad is replaced by a control device selected from a group consisting of activation keys, switches, touch screens, touch films, joysticks, accelerometers, position sensors, motion sensors, electrostatic sensors, control pads, d-pads and click wheels.

13. The method of claim 11, wherein said activation key is replaced by a control device selected from a group consisting of touchpads, switches, touch screens, touch films, joysticks, accelerometers, position sensors, motion sensors, electrostatic sensors, control pads, d-pads and click wheels.
